(19) United States
(12) Patent Application Publication
(10) Pub. No.: US 2015/0017077 A1
(43) Pub. Date: Jan. 15, 2015

(54) SmartPump Fluid Delivery System

(71) Applicants: Bradley V. Farford, Jacksonville Beach, FL (US); Matthew J. Dyszel, Orange Park, FL (US); Evan C. Hathaway, Ponte Vedra Beach, FL (US)

(72) Inventors: Bradley V. Farford, Jacksonville Beach, FL (US); Matthew J. Dyszel, Orange Park, FL (US); Evan C. Hathaway, Ponte Vedra Beach, FL (US)

(21) Appl. No.: 14/331,208

(22) Filed: Jul. 14, 2014

Related U.S. Application Data
(60) Provisional application No. 61/846,587, filed on Jul. 15, 2013.

(51) Int. Cl. A61J 3/00

(52) U.S. Cl. CPC A61J 3/00
USPC 422/509

(57) ABSTRACT

An improved SmartPump Fluid Delivery System is disclosed. In the preferred embodiment of the present invention a system is disclosed for use by pharmaceutical compounders to deliver precise amounts of base material used in transdermal prescriptions. It affords a pharmacist or pharmacy technician the ability to request a desired amount of base material to be delivered accurately and sanitarily to their workstation for processing. By utilizing the current SmartPump Fluid Delivery System a device that provides for the collection, storage, measuring, metering, transportation, and processing of pharmaceutical base material is presented. Further the potential errors, dangers, inaccuracies of compounding base material contamination and processing, and loss of user time associated with the traditional methods, are avoided.

### CROSS-REFERENCES

None

### GOVERNMENT RIGHTS

None

Other Publications

### BACKGROUND OF INVENTION

1. Field of Invention

This invention relates generally to a smart pump system for use by pharmaceutical compounders to deliver precise amounts of base materials used in transdermal prescriptions.

2. Discussion

Traditional pharmaceutical compounding processes involve the mixing of various pharmaceuticals with a base material to create blends of different medications and/or of varying concentration, flavor, or to take a solid to a liquid, etc. The current method begins with the removal of a base materials container lid which exposes its contents, said base material, to all possible forms of contamination. Once the lid is removed a pharmacist or pharmacy technician reaches into the container with a large scoop and retrieves a scoopful of the fluid. The scoopful of fluid is then transferred to a secondary, smaller container for manual transfer to the workstation. Once the smaller container is at a workstation, a smaller, ladle size scoop is used to retrieve amounts of the fluid for use in the compounded prescription. During the compounding process, the technician must add measured amounts of the fluid to create the needed prescription. Currently, technicians use a mass balance to measure these amounts. Scooping fluid amounts accurately is nearly impossible using this method and the outcome may result in a compounded prescription that has too much of the fluid and not enough medication, causing the technician to add more medication to the compound—wasting both money and time.

Several drawbacks to this current method exist, the first of which being possible fluid contamination when the lid of the base container is removed. This can lead directly to organic, non-organic, and/or biological contamination of the container. In the event of biologic contamination of the container, said biologics can feed on and grow in the base material potentially causing patient harm as well as necessitating the disposal of the remaining contents of the container.

A second drawback comes in the act of scooping, which further increases the possibility of contamination through exposure of whatever may be transmitted by the technician. Contaminants may take the form of airborne pathogens, skin cells, hair, fingernails, dust, perfumes, dyes, skin and/or hair care products used by the technician, and/or body fluids expelled from the technician as he/she attempts to retrieve the fluid from the container.

A third drawback arises out of not being able to accurately monitor the usage of the base material volume. In the event that the volume removed for a certain sample to be made by the scoop method is more than what is needed, the excess is discarded. With this method there is no computer monitoring of the amounts used to acquire statistical data for use in material ordering and/or other metrics.

A fourth drawback and additional point of contamination, is the transfer of the base material into the smaller vessel used to carry the base material to a workstation. Not only does this jeopardize the integrity of the sample but additionally increases the probability of cross-contamination through the introduction of foreign material if this vessel has not been properly cleaned and sterilized. Additionally, the use of said transfer vessel at multiple stages of sample processing increases the likelihood of transfer errors. Typically, pharmacists receive multiple orders from numerous patients during the course of a day. As such, the likelihood of confusing a set of samples from different patients or from within the same patient, increases exponentially.

A fifth drawback arises as the technician, after having transferred a scoop of base material into the smaller vessel, travels back to a workstation. As the smaller vessel is typically an open container, the possibility arises for spillage of said material creating a slip hazard for the technician and others.

A sixth drawback arises after the technician has transferred a scoop of base material to a workstation. After a scoop is removed from its container for either single or multiple orders at the workstation, possible error arises as said base material may be exposed to the elements for extended periods of time thereby potentially drying out the base material if left unattended for even relatively short periods of time and potentially causing incorrect concentrations of subsequent medications. While this portion of the compounding process is performed in a sanitary environment, it is still subject to the same forms of contamination as described above, just not in such a critical manner.

A final drawback to this process involves the time it takes a pharmacist or technician to properly complete base material transfer from the drum containers to the corresponding processing cassettes. The more time the pharmacist or technician is involved with transfer, the less time the pharmacist or technician has for properly making the prescription and the more costly the entire process becomes.

One solution is to use a fully sealed and metered base material transfer system to exactly measure out needed amounts of base for prescriptions. An additional benefit of the proposed system is the ability to better track exact usage of bulk material for ordering and cost benefit analysis. Further, the disclosed system thereby limits or eliminates the possibility of bulk base material contamination, or wasted bulk material. Several solutions to these issues exist, however none claim to simultaneously solve all of these problems.

What is needed is a fully automated, self-contained, sterile, metered base material transfer system that can safely and properly measure out needed base material and transfer said material to a technicians workstation, all while being totally sanitary, free of contamination and sealed from the external environment. Therefore it is the object of this invention to solve one or more of these problems.

In the preferred embodiment of the present invention, a system is disclosed for use by pharmaceutical compounders to deliver precise amounts of base material used in transdermal prescriptions. It affords a pharmacist or pharmacy technician the ability to request a desired amount of base material to be delivered accurately and sanitarily to their workstation for processing.

The SmartPump Fluid Delivery System is composed of five main parts: a telescoping pick-up nozzle assembly device; a pump assembly device which can be described as a piston driven self-filling fluid dispenser; a filter assembly device for the second bunghole of a container to ensure no contamination of the container occurs through venting of the container as the base material is removed; a human-machine interface device used for setting and measuring flow rates and quantities used; and an outlet assembly device for the dispensing of said base material.

The telescoping pick-up nozzle assembly is comprised of a set of threaded telescoping tubes of various sizes that, when combined, can be sized to fit pharmaceutical grade base material containers. Compounding base material typically comes in containers ranging in size from 2.5 gal to a 55-gallon drum and are lined in plastic. As the compounding base material comes in a container (55-gallon drum for example) with a plastic liner (a plastic bag), the nozzle of the telescoping nozzle assembly must be inserted into both the bunghole of the container as well as into the bag contained therein. The top of the container plastic liner bag must then be pulled through a two-part collar of the nozzle assembly and pressure sealed with a set of clamps on the outside of the collar. The two-part collar assembly is comprised of a lower collar, which is conical in shape, to accommodate said plastic liner and threaded to mate to both the container bunghole and the upper collar. The upper collar contains a fluid flow sensor to measure the flow of fluid through the lines to the pump device. The fluid flow sensor may also be of the type including but not limited to mechanical-based, pressure-based, optical, open channel, thermal mass flow, vortex, electromagnetic, ultrasonic, and coriolis flow. As the nozzle assembly is properly sealed to the base material container enclosing said plastic bag liner, a filtered vent is needed to prevent the system from forming a vacuum inside of the container, potentially preventing further removal of base material. Said filtered vent is threaded to securely mate with the drum vent bung hole and contains a filter material that may include, but not limited to, paper, ceramic, silica, diatomaceous earth, cellulose, or perlite type material. The filter sits in the distal end of the threaded filter housing and contains a series of slits in the cap to vent the outside atmosphere. Further, the filter also has a check valve on it to prevent the product from drying out.

The nozzle assembly is connected to the inlet check valve of the pump assembly device by a series of tubes which may be PVC, Tygon®, stainless steal, copper or the like with the preferred embodiment being PVC. The inlet check valve of the pump assembly assures that the base material only enters the pump cylinder upon the generation of negative pressure within the pump cylinder. An equivalent exit check valve assures the converse operation upon the generation of positive pressure within the pump.

The pump assembly is a piston driven, self-filling fluid dispenser where the base fluid is metered based on the technicians needs. The base fluid is stored within the cylinder which, in the preferred embodiment, has been sized to hold enough fluid to fill three prescriptions (approx 1.2 liters). Upon signal generation from a human-machine interface (HMI) to deliver a specific amount of base material, the stepper motor activates and a lead screw pushes the piston linearly through a distance that is calculated using a volume equation. The algorithm is programmed into a programmable logic circuit contained in the HMI and uses the cross sectional area of the cylinder and the volume of the cylinder to calculate the distance the piston is to travel to expel the user's desired amount. Once the distance has been reached, the stepper-motor reverses its direction and the piston is pulled back to the top of the cylinder where it lies dormant until the next user input is executed.

When the piston is traveling through the cylinder, the created pressure is exerted on the exit check valve forcing it open. As the piston returns to the rest position, a vacuum is created. The pressure is removed from the exit check valve and the vacuum inside the cylinder allows for the atmospheric pressure to force the base fluid through the inlet check valve, thus, refilling the cylinder to 1.2 L. The pump assembly may also contain an air-bleeder valve located on the high-pressure side of the pump. This valve allows trapped air-pockets in the lines to be removed before the pump forces them to the high-pressure side of the system. To ensure that excessive pressure on the high-pressure side of the piston does not occur, a pressure relief valve will be located on the outer side of the piston (the side not in contact with the fluid). Additional position sensors may be included but not limited to optical encoders and limit switches. This is to ensure that catastrophic failure does not occur due to high pressure anomalies which, if left unchecked, could damage pump parts. The switch may be mechanical, as with a spring loaded trap, or electrical. The electrical version would also contain circuitry which may or may not be located within a single system-circuit.

Additionally the system is setup so that multiple pumps can be attached to the same nozzle assembly via a manifold so that all pumps are pulling from the same container. Further, any number of feed siphons and nozzle assemblies may be attached to the pump assembly device for and from multiple drums of base material. A selector valve to select the appropriate drum or to switch to a new drum when a previous drum is empty may be incorporated between said multiple drums and said pump.

The exit check valve of the pump assembly is connected via tubing to the outlet assembly through a hose nipple/elbow combination used to direct the flow of the fluid through the gate valve to the outlet plenum. The gate valve is designed to cleanly shear the fluid so that it cuts off without having any residual fluid dripping after operating and is used to seal the system at the outlet plenum which functions to prevent splatter and control the flow of the fluid as it is expelled from the system.

The entire system is controlled through the HMI and Hub assembly in which a touchscreen user interface and the controlling circuitry comprising a driver for the stepper motor, and a programmable logic controller for the operation of the various connected components is contained. The HMI may contain all of the controlling circuitry or partly with the remaining circuitry attached to their respective components.

### SUMMARY OF INVENTION

In accordance with the teachings of this invention as embodied and described herein, an improved SmartPump Fluid Delivery System is disclosed. In the preferred embodiment of the present invention, a system is disclosed for use by pharmaceutical compounders to deliver precise amounts of base material used in transdermal prescriptions. It affords a pharmacist or pharmacy technician the ability to request a desired amount of base material to be delivered accurately and sanitarily to their workstation for processing. By utilizing the current SmartPump Fluid Delivery System a device that provides for the collection, storage, measuring, metering, transportation, and processing of pharmaceutical base material is presented. Further, the potential errors, dangers, inaccuracies of compounding base material contamination and processing, and loss of user time, associated with the traditional methods, are avoided.

### BRIEF DESCRIPTION OF DRAWINGS

FIG. 1 is a side view with cut-away of the pump assembly showing the internal piston and seal.

FIG. 2 is an exploded perspective view of the pump assembly.

FIG. 3 is a perspective view of the nozzle assembly.

FIG. 4 is an enlarged perspective view of the upper portion of the nozzle assembly

FIG. 5 is a side view of the outlet assembly.

FIG. 6 is a perspective view of the filter housing showing the machine threads.

FIG. 7 is a perspective view of the human-machine interface.

FIG. 8 is a block diagram of the control unit circuitry.

### DETAILED DESCRIPTION OF THE INVENTION

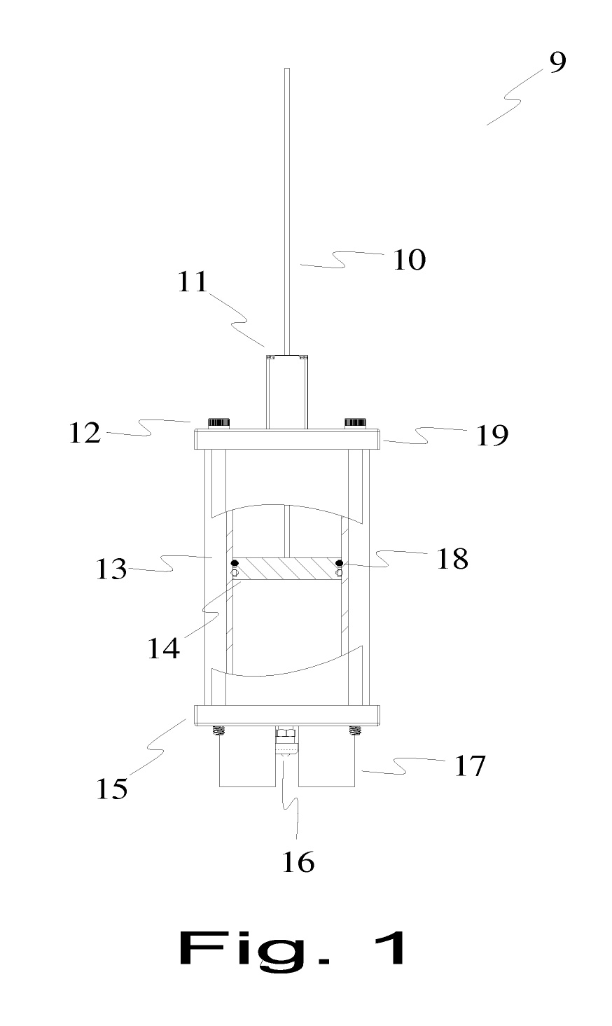

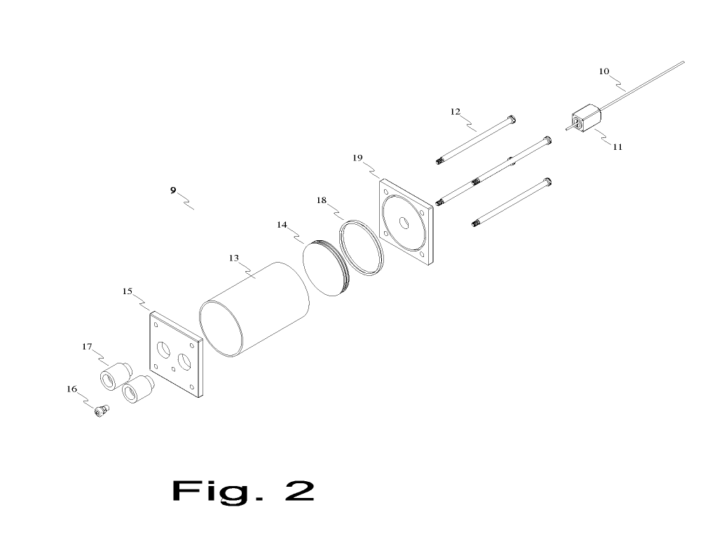

Referring now to the drawings, and more particularly FIGS. 1-2, the present invention includes a pump assembly 9 in the open position with a lead screw 10 attached to a movable piston 14 disposed inside of a cylinder 13 between an upper plate 19 and a lower plate 15, and held together by four body mounting bolts 12. The mounting bolts pass through the upper plate 19 and thread into the lower plate 15 and are used to constrain the cylinder 13 between the two plates and create pressure to compress the O-ring (not shown) between the lower plate 15 and the cylinder 13. This arrangement creates a variable volume chamber by which the piston 14 may move axially. The piston 14 contains a piston O-ring 18 to create a seal between the piston 14 and cylinder 13 bore. Another O-ring is situated between the lower plate 15 and the cylinder 13 to create a seal for the variable volume chamber. The lead screw 10 passes through a stepper motor linear actuator 11 mounted to the upper plate 19, and is used to convert the rotational motion of the stepper motor 11 to linear motion to move the piston 14 up or down so as to either increase or decrease the internal volume respectively and thereby creating a pressure gradient. As the piston 14 moves axially toward the upper plate 19 a negative pressure gradient is created, and away from the upper plate 19 a positive pressure gradient. A pressure relief valve 16 and a series of inlet and exit check valves 17 are mounted to the lower plate 15. To ensure that excessive pressure on the high-pressure side of the piston 14 does not occur, the pressure relief valve 16 will be located on the outer side of the piston 14 (the side not in contact with the fluid). This is to ensure that catastrophic failure does not occur due to high pressure anomalies which if left unchecked could damage pump parts. The switch may be mechanical, as with a spring loaded trap, or electrical. The electrical version would also contain circuitry which may or may not be located within a single system-circuit. The inlet and exit check valves 17 are situated so that when the piston 14 is traveling away from them, one will open to allow fluid to move into the chamber and the other will seal-off the exit side to prevent backflow. When the piston 14 travels in the opposite direction the inlet side closes and the fluid is expelled from the cylinder 13.

The pump assembly 9 in accordance with the present invention may be of any size or shape with the preferred embodiment being sufficiently cylindrical. The pump assembly may be transparent or of any color and may be constructed, formed, machined, extruded, molded, cast, or otherwise made from any suitable material including but not limited to metal, plastic, fiberglass, composite, or the like.

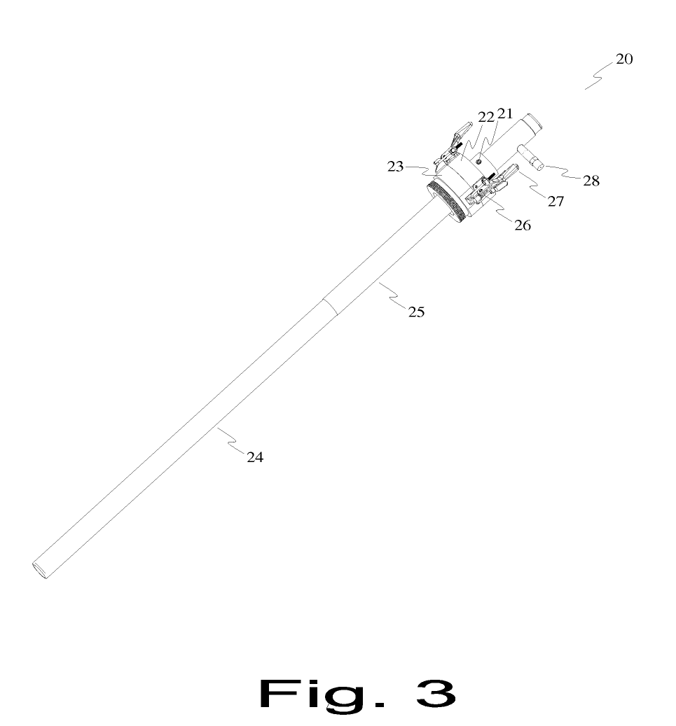

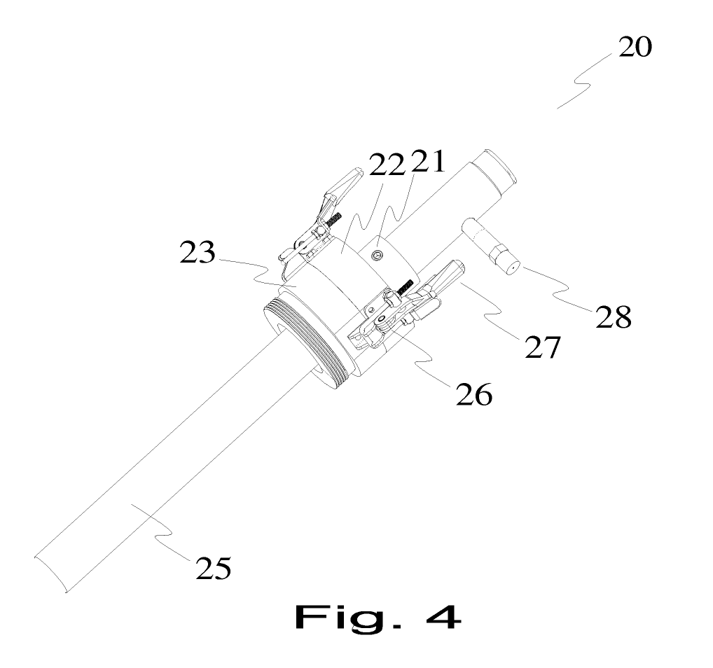

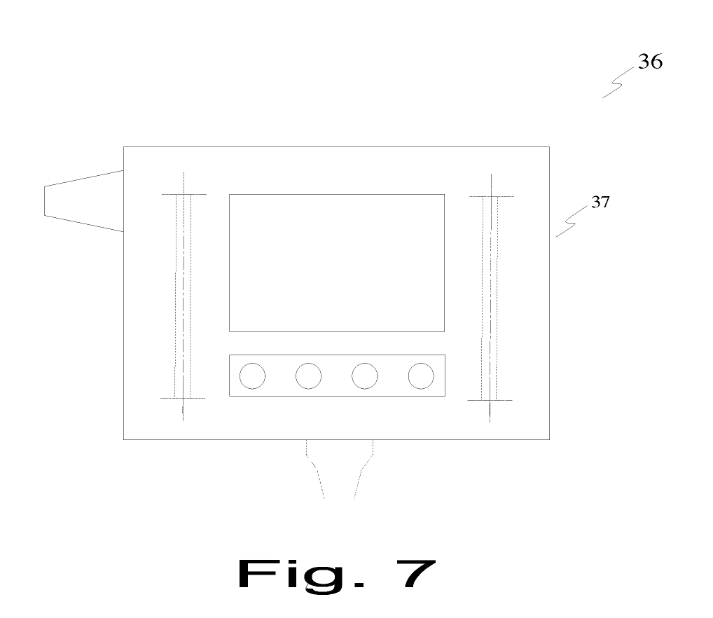

The nozzle assembly 20 in FIGS. 3 and 4, comprise a threaded lower nozzle tube 24 that screws into a threaded upper nozzle tube 25. The nozzle assembly 20 upper and lower tubes 25, 24, may also be telescoping and comprise multiple pieces of varying lengths and diameters to accommodate the range of container sizes available. The upper nozzle 25 is attached to the collar assembly comprised of a lower collar 23, an upper collar 22, a set screw 21, a pressure flow sensor 28, a series of toggle clamps 27, and a series of toggle clamp mounting screws 26. The pressure flow sensor 28, mounted to the nozzle, will read the momentum of the fluid passing by. If air is pulled into the system it will not have enough momentum to activate the flow sensor 28. The result will be a different signal signature that indicates to the human-machine interface 36 (see FIG. 7) that the system is not operating correctly and/or that the nozzle tube is empty. This flow sensor 28 will also have an accompanying circuit and programming that will indicate to the user when barrel is empty or that there is a problem with the system which will result in a system shut-down to prevent damage. Further, the flow sensor 28, meant to measure the fluid flow may also be of the type including but not limited to mechanical-based, pressure-based, optical, open channel, thermal mass flow, vortex, electromagnetic, ultrasonic, and coriolis flow. The upper nozzle tube 25 passes through said collar assembly, the length of which may be set by the set screw 21, and the upper end of said upper nozzle tube 25 is machined into a hose barb (not shown) so that tubing may be attached without extra parts or adapters. The lower collar 23 is threaded so as to screw into the opening of the container that holds the fluid. The upper collar 22 is mounted to the lower collar 23 via pull-action toggle clamps 27, and is conical in shape to fit easily into the lower collar 23. It is designed so that liners used in drums can be pulled through the lower collar 23 and clamped in place between the upper and lower collars 22, 23, with the toggle clamps 27 effectively sealing the liner within. The nozzle assembly 20 may further include a series of slits (not shown) in the side of the lower nozzle tube 24 so as to continue the movement of fluid in the event the open end of the lower nozzle tube 24 is clogged by a container bag.

The nozzle assembly 20 in accordance with the present invention may be of any size or shape with the preferred embodiment being sufficiently cylindrical and designed to mate with containers ranging from 2.5 gal to a 55 gal drum. The nozzle assembly may be transparent or of any color and may be constructed, formed, machined, extruded, molded, cast, or otherwise made from any suitable material including but not limited to metal, plastic, fiberglass, composite, or the like.

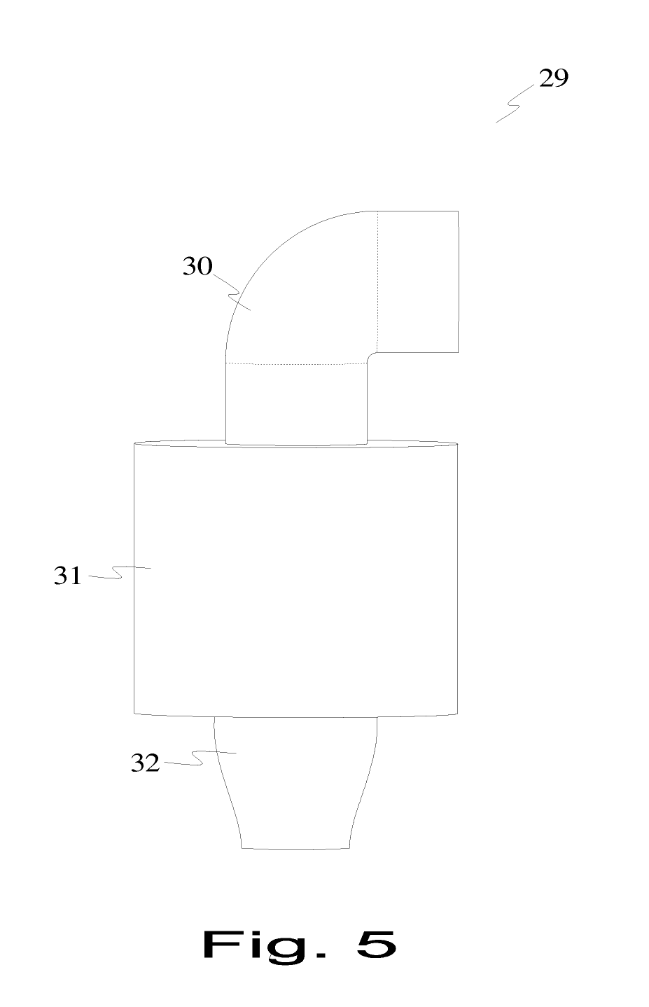

FIG. 5 shows the outlet assembly 29 with a hose nipple/elbow combination 30 used to attach the tubing to the system and direct the flow of fluid through the outlet. The hose nipple/elbow combination 30 is connected to a gate valve 31 used to seal the system at the location at which the fluid is expelled. The gate valve 31 may be mechanical or electrical, with the electrical version being accompanied by circuitry that controls the opening and closing based on the direction the piston travels. An outlet plenum 32 is attached to the gate valve 31 to prevent splatter and control the flow of fluid as it is expelled from the system.

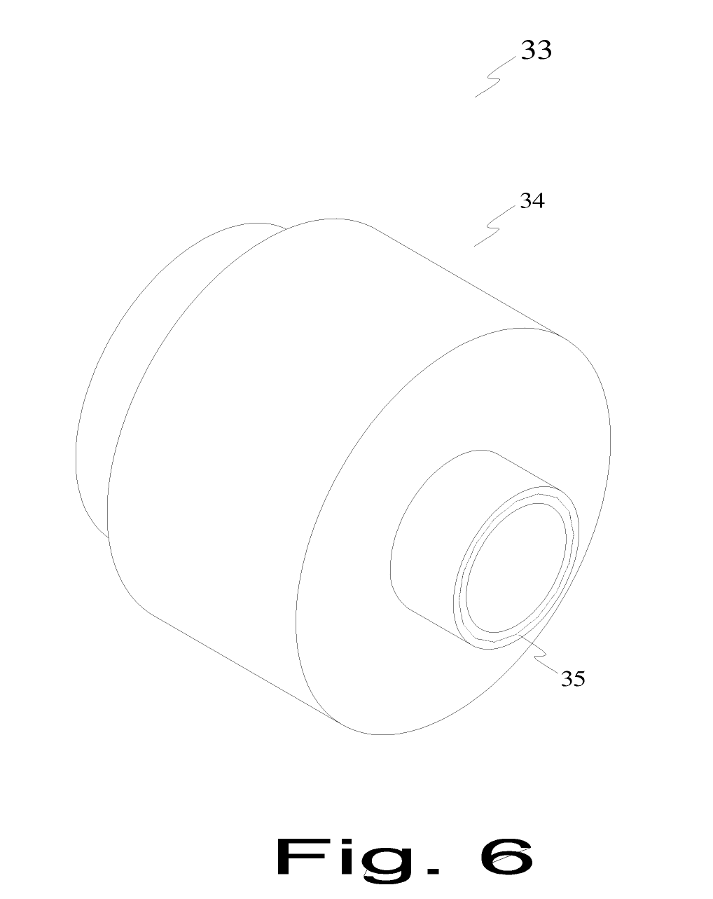

FIG. 6 shows the filter housing assembly 33 comprised of a main body 34 which houses a filter and contains a series of 1-14 machined threads 35 along its connecting end and a series of slits (not shown) diametrically opposed to the 1-14 machined threads 35 to provide a filtered vent to the atmosphere.

FIG. 7 shows a touchscreen human-machine interface 36 which contains a touchscreen user interface, the controlling circuitry 37 comprising a driver for the stepper motor, and a programmable logic controller for the operation of the various connected components. The HMI 36 may contain all of the controlling circuitry 37 or partly with the remaining circuitry 37 attached to their respective components.

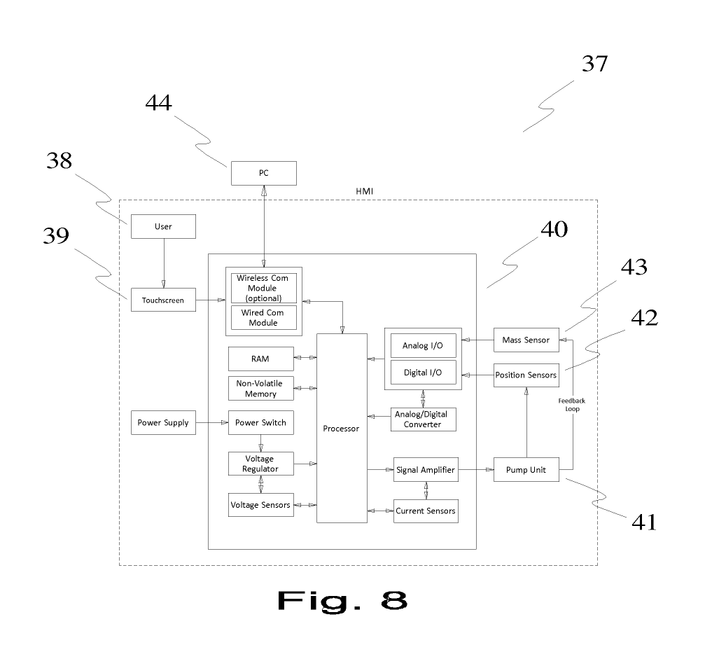

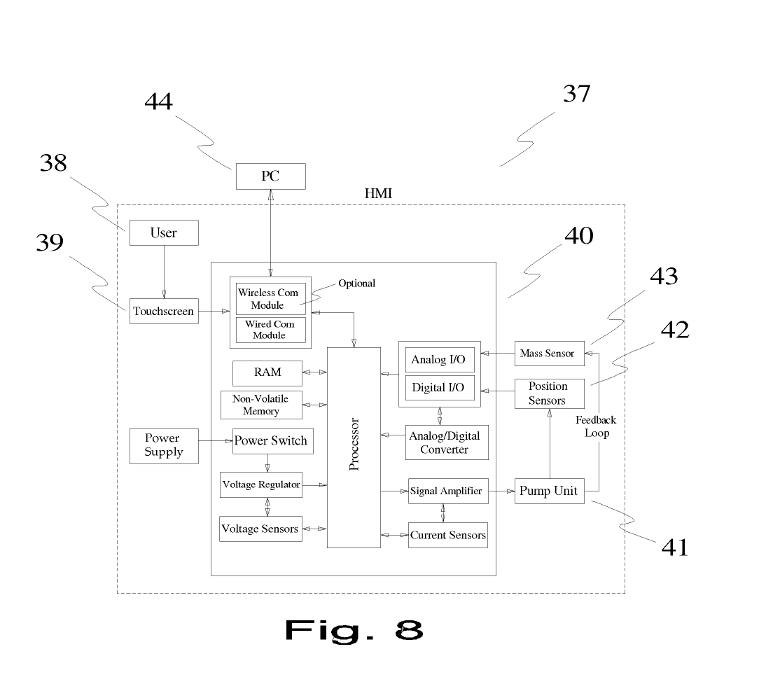

FIG. 8 shows a block diagram of the controlling circuitry 37 of the HMI 36 in which the user 38 specifies a fluid to be dispensed from the HMI 36 via the touchscreen 39. By specifying the fluid, the control unit 40 determines which pump unit(s) 41 to operate. Multiple fluid pump units may be hooked up to one control unit 40. The user 38 then specifies the operating function via the touchscreen 39. Signals may be sent from the HMI/touchscreen 39 to the control unit 40 by a wired or wireless transfer. The signals are processed by the control unit 40 to send the action to the motor or pump unit(s) 41 to operate. Position sensors 42 monitor the pump unit(s) 42 operation to ensure safety of the system and will interrupt the pump unit(s) 42 operation if necessary. Additionally, mass sensors 43 are used as a feedback loop to the control unit 40 to monitor the amount of fluid being dispensed. Lastly the entire system may be connected to a PC 44 network which allows for user 38 tracking and the ability to transfer prescriptions to the control unit to view or to be automatically dispensed. It is foreseeable to have the entire system fully automated. As such, the user 38 indicates the prescription desired, information is sent from the PC 44 network to the control unit 40 whereby it is processed to determine the amount of fluids to be added to the batch.

The various embodiments of the present invention as shown in FIGS. 1-8 may be arranged and designed in a wide variety of different configurations that fall within the scope of the present invention, and may be applied to any type of system involving the collection, storage, metering, transportation and/or processing of base material for pharmaceutical compounders.

In short the improved Smartpump fluid delivery system provides a unique design for the safe, sterile, efficient, and effective handling of base material for use by pharmaceutical compounders. By utilizing the improved system, base material loss is prevented, substantial errors are eliminated and time is saved in processing medical prescriptions.

The foregoing discussion discloses and describes merely exemplary embodiments of the present invention. One skilled in the art will readily recognize from such discussion and from the accompanying drawings and claims, that various changes, modifications and variations can be made therein without departing from the spirit and scope of the invention as defined in the following claims.

The invention claimed is:

1. An apparatus for the sterile collection, storage, transportation, metering, and processing of a base material for use by pharmaceutical compounders, the apparatus comprising:
a nozzle assembly device for the measuring and transferring of a fluid base material from a container;
a pump device connected to said nozzle assembly device for metering specified volumes of said fluid base material;
an outlet assembly device connected to said pump device for the controlled dispensing of said fluid base material;
a filter assembly device attached to said container for the filtered venting of said container atmosphere;
a human-machine interface device attached to said nozzle assembly device, pump device, and outlet assembly device; and
wherein said pump device has a linear actuator which drives said pump volume measurements.

2. The apparatus of claim 1, wherein said pump device is linearly actuated and capable of variable volumes.

3. The apparatus of claim 1, wherein said nozzle assembly device is made to attach to a container for the transfer of fluid from said container.

4. The apparatus of claim 1, wherein said nozzle assembly device contains a flow sensor.

5. The apparatus of claim 1, wherein said filter assembly device contains a filter material.

6. The apparatus of claim 1, wherein said pump device incorporates an air-bleeder valve on the high pressure side to vent air bubbles in the lines.

7. The apparatus of claim 1, wherein a multitude of said pump assembly devices are attached to the same nozzle assembly device via a manifold so that all pump assemblies are pulling from the same container.

8. The apparatus of claim 1, wherein a multitude of feed siphons and said nozzle assembly devices may be attached to said pump assembly device from multiple containers of base material.

9. The apparatus of claim 1, wherein a selector valve is attached to said pump to select an appropriate container or to switch to a new container when a previous one is empty.

10. The apparatus of claim 1, wherein said human-machine interface device incorporates a touchscreen user interface, a stepper motor driver circuit, and a programmable logic controller circuit for the operation of the various connected components.

11. An apparatus for the sterile collection, storage, transportation, metering, and processing of a base material for use by pharmaceutical compounders, the apparatus comprising:
a nozzle assembly device for the measuring and transferring of a fluid base material from a container;
a pump device connected to said nozzle assembly device for metering specified volumes of said fluid base material;
an outlet assembly device connected to said pump device for the controlled dispensing of said fluid base material;
a filter assembly device attached to said container for the filtered venting of said container atmosphere;
a human-machine interface device attached to said nozzle assembly device, pump device, and outlet assembly device;
wherein said pump device is linearly actuated and has a linear actuator with circuitry which drives said pump volume measurements;
wherein said pump device incorporates an air-bleeder valve on the high pressure side to vent air bubbles in the lines;
wherein said filter assembly device contains a filter material;
wherein said nozzle assembly device is made to attach to a container for the transfer of fluid from said container and contains a pressure flow sensor for the measurement of fluid flow; and
wherein said human-machine interface device incorporates a touchscreen user interface, a linear actuator driver circuit, and a programmable logic controller circuit.
